(19) United States
(12) Patent Application Publication
(10) Pub. No.: US 2014/0244342 A1
(43) Pub. Date: Aug. 28, 2014

(54) ACCOUNTING FOR CONTRACT FORMATION AND FULFILLMENT ACTIVITIES

(71) Applicant: MICROSOFT CORPORATION, Redmond, WA (US)

(72) Inventors: Arthur Greef, Burien, WA (US); John Healy, Fargo, ND (US); Michael Gall, Kopenhagen (DK); Xavier Chape, Stenlose (DK); Par Akerblom, North Bend, WA (US); Manoj Swaminathan, Issaquah, WA (US)

(73) Assignee: Microsoft Corporation, Redmond, WA (US)

(21) Appl. No.: 13/775,472

(22) Filed: Feb. 25, 2013

(51) Int. Cl. G06Q 10/06

(52) U.S. Cl. CPC G06Q 10/06316
USPC 705/7.26

(57) ABSTRACT

Technologies are generally described for accounting for contract formation and fulfillment activities by combination event chaining and multidimensional measurement chaining, with event and measurement matching rules that apply variance and tolerance policies during evaluation. Building on chaining basis and derived measurements that participate in an equality relationship, chaining measurements may participate in a matching rule that applies tolerance policies. Furthermore, measurement chaining may be updated when the documented consequence of events are corrected or changed.

### BACKGROUND

With the proliferation of computing and networking technologies, conventional business tasks are increasingly automated through hosted business applications. Multi-faceted services addressing a variety of operational needs such as accounting, customer relationship management, inventory management, and similar ones are provided through a hosted service enabling multiple clients to take advantage of centralized solutions while having access for their users through thin or specialized client applications. One of the coveted aspects of business applications or services, accounting, typically allows a wide variety of enterprise operations to be performed and supervised through standardized and regulation-compliant approaches.

Organizations and people that buy and sell goods and services need to account for their contract formation and fulfillment activities. For example, an organization that places a purchase order with a vendor may be obligated to pay by check in consideration for the product they receive once they have been sent a vendor invoice. Accounting for each occurrence of a contract formation and fulfillment activity may require a method of documenting, matching, and journalizing the social, operational, and financial consequences of each event. For example, each purchase event may need to be matched with a product receipt event, a cash settlement request receipt event, a cash disbursement event, and a ledger recognition event.

The real world, however, makes it difficult to account for the variances in contract formation and fulfillment activities. For example, a purchase order may document a purchase of 10 kg of a measurable product with a quantity tolerance clause or policy that binds a buyer to accept the contract as fulfilled on delivery of the product that is as light as 9.5 kg and as heavy as 10.5 kg. Similarly, the purchase order may document a quoted price of $10.00 with a price tolerance clause or policy that binds the buyer to accept a price quote increase to $10.50. Similar implicit or explicit tolerance clauses may exist for documented change and discount terms. However, documentation of the variances for different aspects in light of changes or corrections may present a challenge to automated accounting services or local applications.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to accounting for contract formation and fulfillment activities by combination event chaining and multidimensional measurement chaining, with event and measurement matching rules that apply variance and tolerance policies during evaluation. Building on chaining basis and derived measurements that participate in an equality relationship (for example, Extended price=Product quantity*Unit price), chaining measurements may participate in a matching rule that applies tolerance policies. Furthermore, measurement chaining may be updated when the documented consequence of events are corrected or changed.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example schema for accounting for contract formation and fulfillment activities an integrated and extensible accounting system;

FIG. 2 illustrates an example schema for two example processes for accounting for contract formation and fulfillment activities according to some embodiments;

FIG. 3 illustrates another example schema for two other example processes for accounting for contract formation and fulfillment activities according to some embodiments;

FIG. 4 is a networked environment, where a system according to embodiments may be implemented;

FIG. 5 is a block diagram of an example computing operating environment, where embodiments may be implemented;

FIG. 6 illustrates a logic flow diagram for a process of providing accounting for contract formation and fulfillment activities according to embodiments, where documentation events are chained to operations event along with chaining of derived multidimensional measurements to basis measurements and chaining of matched multidimensional measurements; and

FIG. 7 illustrates a logic flow diagram for a process of providing accounting for contract formation and fulfillment activities according to embodiments, where documentation multidimensional measurements are generated along with chaining of derived multidimensional measurements to basis measurements and chaining of matched multidimensional measurements.

### DETAILED DESCRIPTION

As briefly described above, chaining measurements may participate in a matching rule that applies tolerance policies in addition to chaining basis and derived measurements that participate in a formula. Measurement chaining may also be updated when the documented consequence of events are corrected or changed in an approach to accounting for contract formation and fulfillment activities according to some embodiments. For more complex contractual formation and fulfillment activities, embodiments may be extended to include advanced shipping notification and quality inspection.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable hardware. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

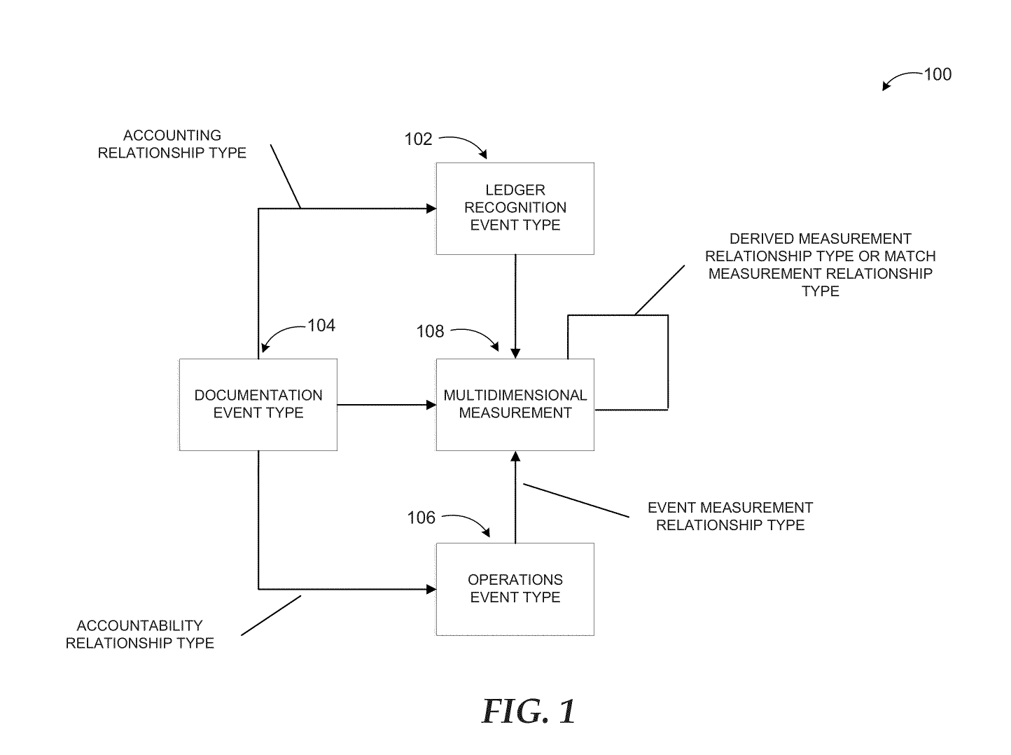

FIG. 1 illustrates an example schema for accounting for contract formation and fulfillment activities an integrated and extensible accounting system.

As discussed previously, documentation of the variances in contract formation and fulfillment activities for different aspects in light of changes or corrections may present a challenge to automated accounting services or local applications. One approach to accounting for the formation and fulfillment of contracts within accounting systems matches documents parts. For example, a purchase order line may be matched with a product receipt line and the contract may be considered fulfilled by the buyer if the quantity of product received is with the limits of the agreed tolerance. Similarly, a purchase order line may be matched with a vendor invoice line and a payment authorized if the payment claim amount on the vendor invoice is within the tolerance of the price quoted on the purchase order. However, the logic of matching documents and lines as well as matching variances against tolerances typically needs to be implemented each time a new document type or document type variant is needed. Moreover, outstanding product quantities may have to be updated on the purchase order, which can lead to performance issues and difficulty in maintenance when documents are corrected and changed.

Another approach matches document parts and documented quantity distributions. For example, a product quantity of 100 kg documented on a purchase order line may be internally distributed to allocate 50 kg of the product to department A and 50 kg of the product to department B. The above-mentioned issues may also persist with this approach.

A further approach employed by the economic Resources, economic Events, and economic Agents (REA) Accounting Model matches documented events such as purchase events with product receipt events and claim settlement request events. This approach may involve a large number of events to be documented. For example, an event may have to be documented for the receipt of an exact quantity of product and one or more additional events may be needed for receipts above the exact amount even though the amount is within tolerance. Additional events may also be needed for when correcting or changing the document consequences of events.

An example approach to accounting for contract formation and fulfillment activities according to some embodiments may be implemented by combining event chaining and multidimensional measurement chaining with event and measurement matching rules that apply variance and tolerance policies during evaluation. Chaining measurements may participate in a matching rule that applies tolerance policies with the measurement chaining being updated when the documented consequence of events are corrected or changed.

As shown in diagram 100, contract formation and fulfillment events may be classified as documentation events 104, operations events 106, or ledger recognition events 102. Documentation, operations, and recognition events may then be chained in event chains. Multidimensional measurements including tolerance measurements 108 may be generated from operations policies and the multidimensional matching rules may be applied to chain measurements that quantify the operational consequences of contract formation and fulfillment activities. The measurements may also be chained when the documented consequence of events are corrected or changed.

Documentation events 104 defined by a documentation event type may be related to ledger recognition events 102 (defined by a ledger recognition event type) through an accounting relationship type and to operations events 106 (defined by an operations event type) through an accountability relationship type. The three core events may be related to the multidimensional tolerance measurements 108 through event measurement relationship types.

Thus, a system according to embodiments may match events and measurements, and not document parts making it possible to implement the approach in an application framework that can be shared by all documents. The ability to implement in a shareable framework may lower the cost and complexity of extending the application to new domains. Outstanding quantities may not need to be stored on documents, instead in measurements resulting again in lower cost and complexity of application development and extension when the approach is implemented in a framework. Generation of unnecessary events to account for variances in contract formation and fulfillment activities may be avoided. Furthermore, generation of unnecessary events when processing corrections or changes to the documented consequences of events may also be avoided.

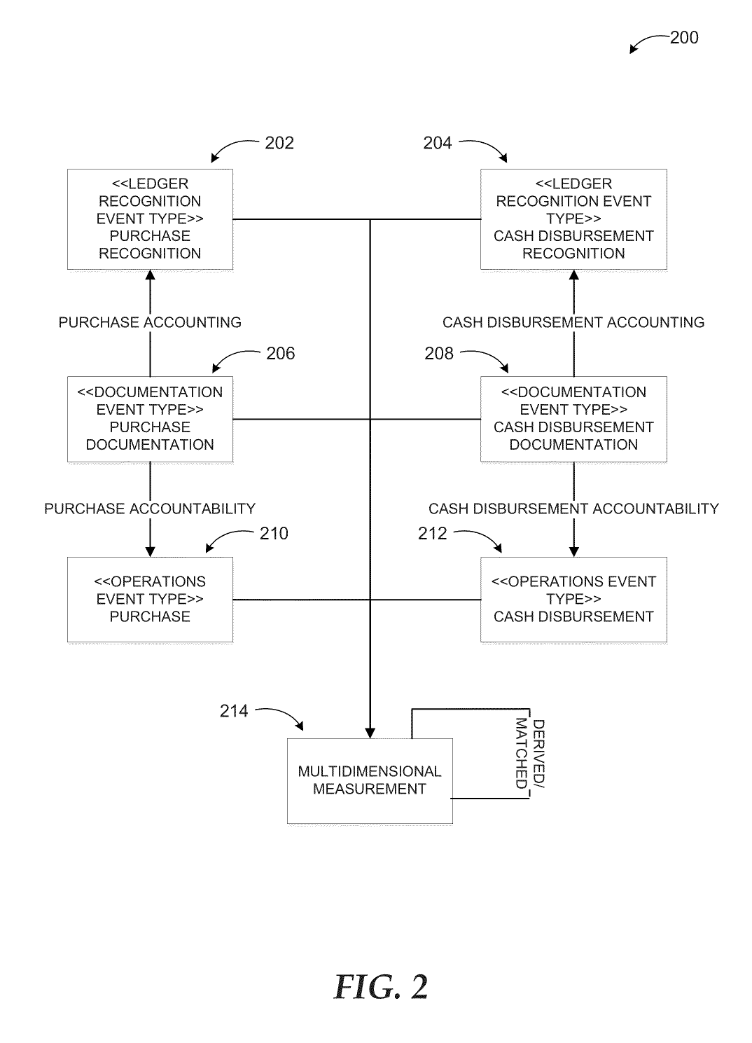

FIG. 2 illustrates an example schema for two example processes for accounting for contract formation and fulfillment activities according to some embodiments.

According to the example scenario shown in diagram 200, capture of a purchase event as purchase documentation 206 by the documentation process may result in creation of a purchase event 210 by the operations accountability process and a purchase recognition event 202 by the ledger recognition process. The events may be chained through purchase accountability type and purchase accounting type properties, respectively. Similarly, capture of a cash disbursement event 208 by the documentation process may result in a cash disbursement operations event 212 by the operations accountability process and a cash disbursement recognition event 204 by the ledger recognition process. The events may be chained through respective cash disbursement accountability and cash disbursement accounting properties.

Along with the documentation of the purchase and cash disbursement events, multidimensional measurements 214 may be created and chained as discussed in more detail below.

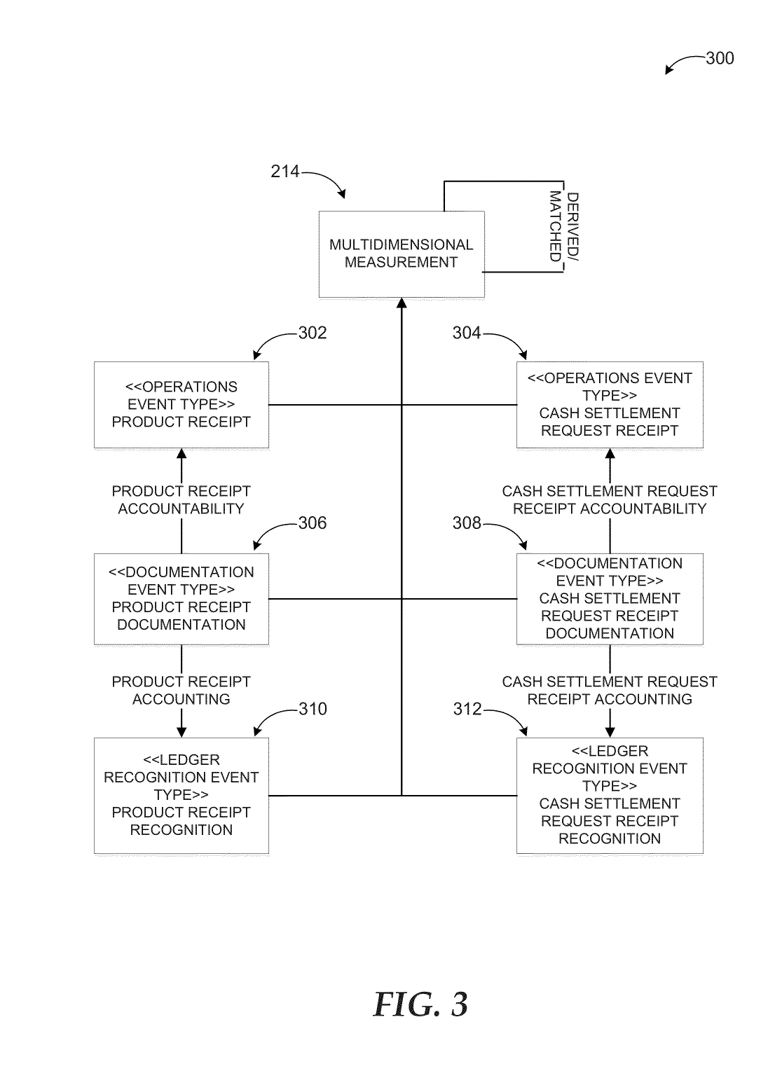

FIG. 3 illustrates another example schema for two other example processes for accounting for contract formation and fulfillment activities according to some embodiments.

According to the example scenario shown in diagram 300, capture of a product receipt event as product receipt documentation 306 by the documentation process may result in creation of a product receipt operations event 302 by the operations accountability process and a product receipt recognition event 310 by the ledger recognition process. The events may be chained through product receipt accountability type and product receipt accounting type properties, respectively. Similarly, capture of a cash settlement request event 308 by the documentation process may result in a cash settlement request operations event 304 by the operations accountability process and a cash settlement request recognition event 312 by the ledger recognition event chained through respective cash disbursement accountability and cash disbursement accounting properties. Similar to the examples in FIG. 2, along with the documented events, associated multidimensional measurements 214 may be created and chained.

An example flow through a system according to embodiments is provided below. The example scenarios, configurations, order of steps, and results described below are for illustration purposes only and do not constitute a limitation on embodiments.

Step 1 Document consequences of contract
formation and fulfillment economic events
Purchase Order

| | | | | Upper Product Quantity |
|---|---|---|---|---|
| Item | Quantity | Unit Price | Ext. Price | Tolerance Percent |
| Product | 10 units | $100.00 | $1,000.00 | 20% |
| | | Total: | $1,000.00 | |

Product Receipt

| Item | Quantity |
|---|---|
| Product | 12 units |

Vendor Invoice

| Item | Quantity | Unit Price | Ext. Price |
|---|---|---|---|
| Product | 12 units | $100.00 | $1,200.00 |
| | | Total: | $1,200.00 |

Cheque

| Payor | Payee | Payment |
|---|---|---|
| Customer | Vendor | $1,200.00 |

Bank Statement

| Holder | Party | Cash | Financial Institution/Cash Acct. |
|---|---|---|---|
| Customer | Vendor | $(1,200.00) | Bank/Bank Account |

Step 2 - Generate Documentation events and measurements
Measurements

| Document | Event | Measure | Measurement |
|---|---|---|---|
| Purchase Order | Purchase | Term/Total Purchase | $1,000.00 |
| | Documentation | Price/Consideration | |
| Purchase Order | Purchase | Schedule/Cash | $1,000.00 |
| | Documentation | Quantity/Obligation | |
| Product Receipt | Product Receipt | | |
| | Documentation | | |
| Vendor Invoice | Cash Settlement | Term/Total Product | $1,200.00 |
| | Request Receipt | Price/Claim | |
| | Documentation | | |
| Vendor Invoice | Cash Settlement | Schedule/Cash | $1,200.00 |
| | Request Receipt | Quantity/Claim | |
| | Documentation | | |
| Cheque | Cash Disbursement | Term/Total Product | $1,200.00 |
| | Documentation | Price/Claim | |
| Cheque | Cash Disbursement | Schedule/Cash | $1,200.00 |
| | Documentation | Quantity/Obligation | |
| Bank Statement | Cash Settlement | Term/Cash Quantity/Give | $1,200.00 |
| | Documentation | | |
| Bank Statement | Cash Settlement | Schedule/Cash | $1,200.00 |
| | Documentation | Quantity/Give | |

Step 3 - Generate operations events and measurements
Measurements

| Document | Event | Measure | Measurement |
|---|---|---|---|
| Purchase Order | Purchase | Term/Extended | $1,000.00 |
| | | Price/Consideration | |
| Purchase Order | Purchase | Term/Product | 10 units- |
| | | Quantity/Consideration | Product1 |
| Purchase Order | Purchase | Schedule/Product | 10 units- |
| | | Quantity/Consideration | Product1 |
| Purchase Order | Purchase | Term/Upper Product Quantity | 20% |
| | | Tolerance/Consideration | |
| Purchase Order | Purchase | Term/Upper Tolerance Product | 2 units- |
| | | Quantity/Consideration | Product |
| Purchase Order | Purchase | Schedule/Cash | $1.000.00 |
| | | Quantity/Obligation | |
| Product Receipt | Product Receipt | Term/Product Quantity/Take | 12 units- |
| | | | Product1 |
| Product Receipt | Product Receipt | Schedule/Product Quantity/Take | 12 units- |
| | | | Product1 |
| Vendor Invoice | Cash Settlement | Term/Product Quantity/Claim | 12 units- |
| | Request Receipt | | Product1 |
| Vendor Invoice | Cash Settlement | Term/Extended Price/Claim | $1,200.00 |
| | Request Receipt | | |
| Cheque | Cash Disbursmt. | Term/Payment/Remittance | $1,200.00 |
| Cheque | Cash Disbursmt. | Schedule/Payment/Remittance | $1,200.00 |
| Bank Statement | Cash Settlement | Term/Cash Quantity/Give | $1,200.00 |
| Bank Statement | Cash Settlement | Schedule/Cash Quantity/Give | $1,200.00 |

Step 4 - Chain documentation event to operations event
Event Chain

| Documentation Event | Operations Event | Relationship |
|---|---|---|
| Purchase Documentation | Purchase | Purchase Accountability |
| Product Receipt | Product Receipt | Product Receipt |
| Documentation | | Accountability |
| Cash Settlement Request | Cash Settlement | Cash Settlement Request |
| Receipt Documentation | Request Receipt | Receipt Accountability |
| Cash Disbursement | Cash Disbursement | Cash Disbursement |
| Documentation | | Accountability |
| Cash Settlement | Cash Disbursement | Cash Disbursement |
| Documentation | | Accountability |

Step 5-Chain derived measurements to basis measurements
Measurements

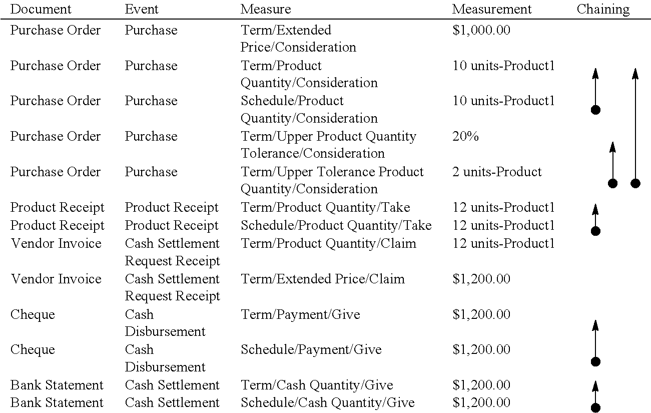

Step 6 - Chain matched measurements
Match 10 received Product units with the purchase quantity of
10 Product units even though 12 Product units received
Match $1000 claimed against purchase obligation even though
$1200 claimed on invoice
Matched Measurements

| Measurement | Matched Measurement | Magnitude |
|---|---|---|
| Term/Product Quantity/Take | Term/Product Quantity/Consideration | 10 |
| Term/Product Quantity/Take | Term/Upper Tolerance Product | 2 |
| | Quantity/Consideration | |
| Schedule/Product Quantity/Take | Schedule/Product Quantity/Consideration | 10 |
| Schedule/Product Quantity/Take | Schedule/Product Quantity/Consideration | 2 |
| Term/Product Quantity/Claim | Schedule/Product Quantity/Take | 12 |
| Term/Product Quantity/Claim | Schedule/Product Quantity/Consideration | 10 |
| Term/Product Quantity/Claim | Schedule/Product Quantity/Consideration | 2 |
| Term/Extended Price/Claim | Term/Extended Price/Take | 1200 |
| Schedule/Cash | Schedule/Cash Quantity/Claim | 1200 |
| Quantity/Remittance | | |
| Schedule/Cash Quantity/Give | Schedule/Cash Quantity/Remittance | 1200 |

Step 7 - Chain reciprocal event measurements
Reciprocal Measurements

| | | |
|---|---|---|
| | Reciprocal | Relationship |
| Measurement | Measurement | Type |

| | | | | |
|---|---|---|---|---|
| Schedule/Product | 10 units- | Schedule/Cash | $1,000.00 | Reciprocity |
| Quantity/Consideration | Xbox | Quantity/Obligation | | |
| Schedule/Product | 2 units- | Schedule/Cash | $200.00 | Reciprocity |
| Quantity/Consideration | Xbox | Quantity/Obligation | | |
| Schedule/Product | 12 units- | Schedule/Product | 10 units- | Fulfillment |
| Quantity/Take | Xbox | Quantity/ | Xbox | |
| | | Consideration | | |
| Schedule/Product | 12 units- | Schedule/Product | 2 units- | Fulfillment |
| Quantity/Take | Xbox | Quantity/Consideration | Xbox | |
| Schedule/Cash | $1,200,00 | Schedule/Cash | $1,000.00 | Fulfillment |
| Quantity/Give | | Quantity/Obligation | | |

Step 7 - Ledger accounting recognition events and measurements
Measurements

| Event | Measure | Measurement | Type |
|---|---|---|---|
| Purchase | Recognition/Product Cost | 10 units-Product | Ledger Accounting |
| Recognition | Quantity/Estimation | | |
| Purchase | Recognition/Product | $1,000.00 | Ledger Accounting |
| Recognition | Cost/Estimation | | |
| Product Receipt | Recognition/Product Cost | 10 units-Product | Ledger Accounting |
| Recognition | Quantity/Realization | | |
| Product Receipt | Recognition/Product Cost Quantity | 2 units-Product | Ledger Accounting |
| Recognition | Variance/Realization | | |
| Product Receipt | Recognition/Product | $1,000.00 | Ledger Accounting |
| Recognition | Cost/Realization | | |
| Product Receipt | Recognition/Product | $200.00 | Ledger Accounting |
| Recognition | Cost/Realization | | |
| Product Receipt | Accounting currency/Product | $1,200.00 | Subledger accounting |
| Recognition | receipt/Primary | | |
| Product Receipt | Accounting currency/Purchase, | $(1,200.00) | Subledger accounting |
| Recognition | accrual/Opposite | | |
| Cash Settlement | Accounting currency/Inventory | $1,200.00 | Subledger accounting |
| Request Receipt | receipt/Primary | | |
| Recognition | | | |
| Cash Settlement | Accounting currency/Vendor | $(1,200.00) | Subledger accounting |
| Request Receipt | balance/Opposite | | |
| Recognition | | | |
| Cash Disbursement | Accounting currency/Cash in | $(1,200.00) | Subledger accounting |
| Recognition | transfer/Primary | | |
| Cash Disbursement | Accounting currency/Vendor | $1,200.00 | Subledger accounting |
| Recognition | balance/Opposite | | |
| Cash Settlement | Accounting currency/Bank/ | $(1,200.00) | Subledger accounting |
| Recognition | Primary | | |

Step 8 - Chain documentation event to ledger recognition event
Event Chain

| | Ledger | |
|---|---|---|
| Event | Recognition Event | Relationship |
| Purchase Documentation | Purchase Recognition | Purchase |
| | | Accounting |
| Product Receipt | Product Receipt | Product Receipt |
| Documentation | Recognition | Accounting |
| Cash Settlement Request | Cash Settlement Request | Cash Settlement |
| Receipt Documentation | Receipt Recognition | Request Receipt |
| | | Accounting |
| Cash Disbursement | Cash Disbursement | Cash Disbursement |
| Documentation | Recognition | Accounting |
| Cash Settlement | Cash Settlement | Cash Settlement |
| Documentation | Recognition | Accounting |

The above discussed configurations are example configurations for illustrative purposes. Embodiments may be implemented with other configurations and approaches using the principles described herein.

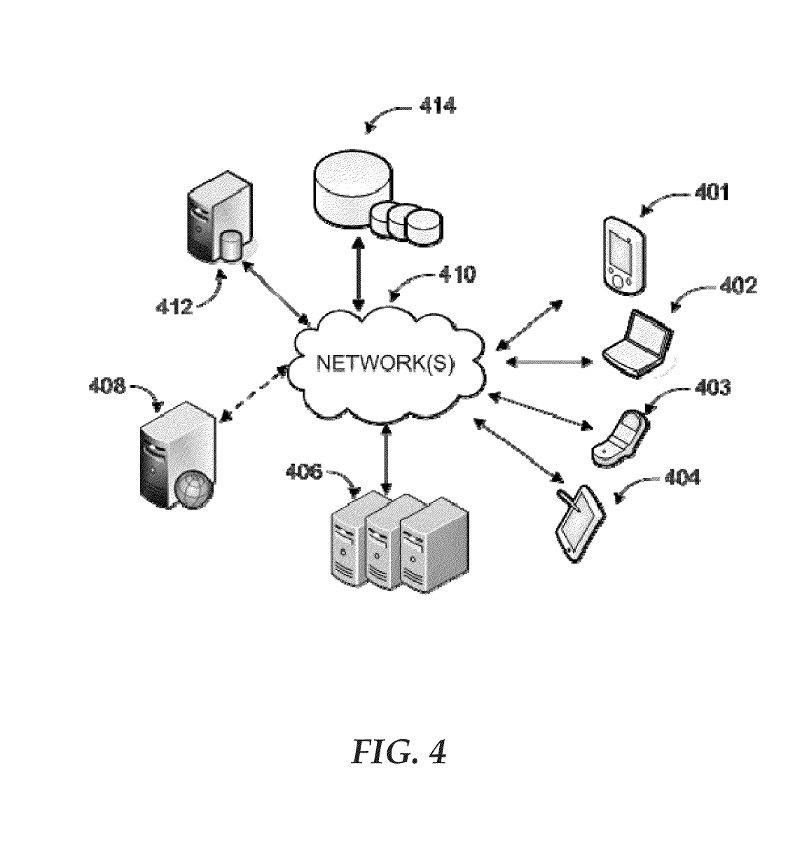

FIG. 4 is an example networked environment, where embodiments may be implemented. In addition to locally installed applications, such as accounting service 522 discussed below, an accounting service may also be employed in conjunction with hosted applications and services that may be implemented via software executed over one or more servers 406 or individual server 408. A hosted accounting service or application may be a web-based service or application, a cloud based service or application, and similar ones, and communicate with client applications on individual computing devices such as a handheld computer 401, a laptop computer 402, a smart phone 403, or a tablet computer 404 (‘client devices’) through network(s) 410 and control a user interface presented to users. Such a service may enable users to interact with accounting service allowing them to feed input, modify operational parameters, receive analysis results, define operational parameters, etc. as discussed herein.

Client devices 401-404 are used to access the functionality provided by the hosted service or application. One or more of the servers 406 or server 408 may be used to provide accounting service as discussed above providing an approach to accounting for contract formation and fulfillment activities by combining event chaining and multidimensional measurement chaining with event and measurement matching rules that apply variance and tolerance policies during evaluation. Relevant data may be stored in one or more data stores (e.g. data store 414), which may be managed by any one of the servers 406 or by database server 412.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to provide accounting for contract formation and fulfillment activities by combining event chaining and multidimensional measurement chaining with event and measurement matching rules that apply variance and tolerance policies during evaluation. Furthermore, the networked environments discussed in FIG. 4 are for illustration purposes only. Embodiments are not limited to the example applications, modules, or processes.

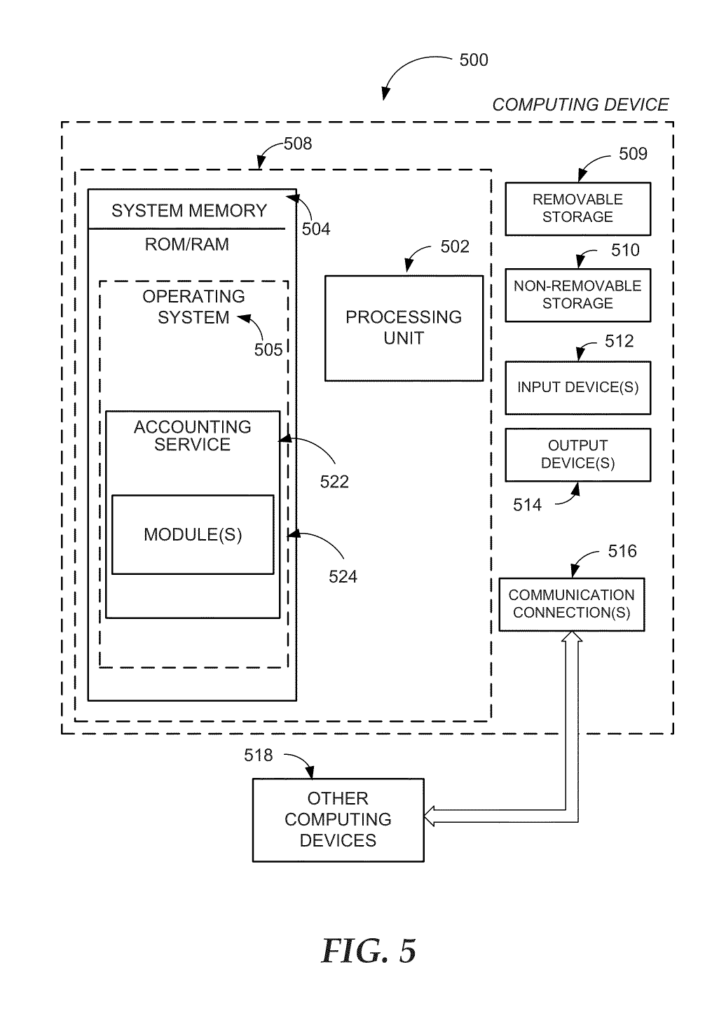

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server executing an accounting service as described herein, and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as accounting service 522 and one or more modules 524.

Accounting service 522 may enable performance of various accounting related tasks enabling accounting for contract formation and fulfillment activities by combining event chaining and multidimensional measurement chaining with event and measurement matching rules that apply variance and tolerance policies during evaluation. Different aspects of the accounting tasks may be performed by the one or more modules 524 according to a configuration of the accounting service 522. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or inure of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some operations. These human operators need not be collocated with each other, but each can be only with a machine that performs a portion of the program.

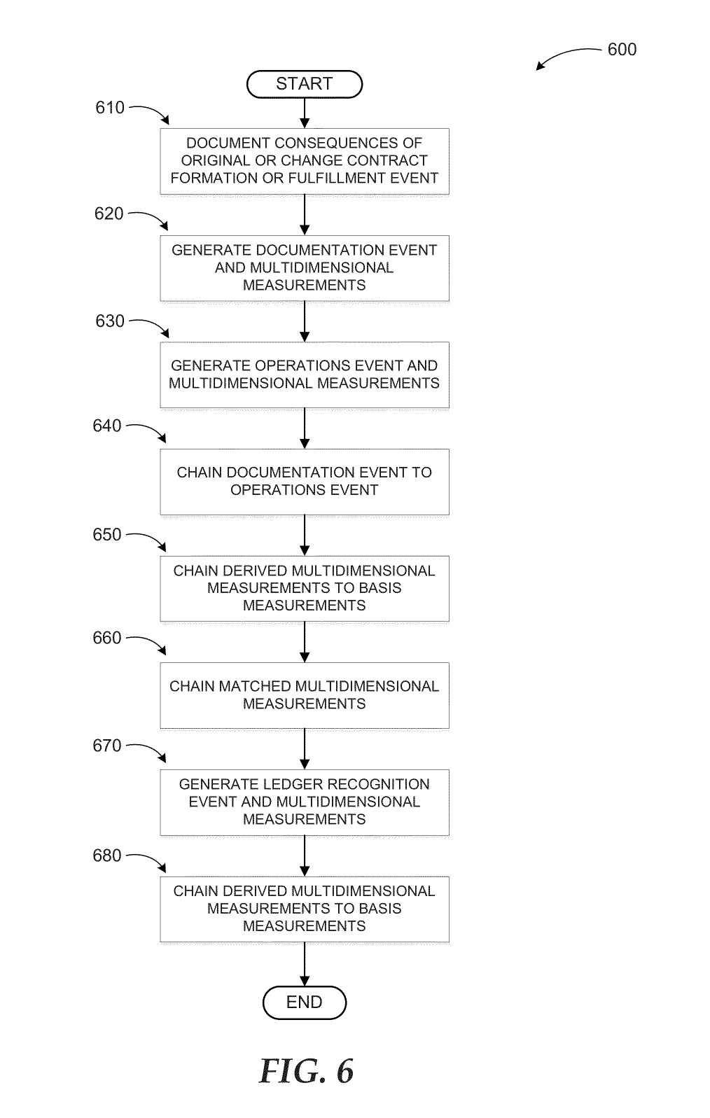

FIG. 6 illustrates a logic flow diagram for a process of providing accounting for contract formation and fulfillment activities according to embodiments, where documentation events are chained to operations event along with chaining of derived multidimensional measurements to basis measurements and chaining of matched multidimensional measurements.

Process 600 begins with operation 610, where consequences of an original contract formation or fulfillment event as well as a change to a similar event are documented. At operation 620, a documentation event and multidimensional measurements related that event may be generated. At a subsequent operation 630, an operations event and associated multidimensional measurements may be generated.

At operations 640 through 660, various chainings may be performed. For example, the documentation event may be chained to the operations event, derived multidimensional measurements may be chained to basis measurements, and matched multidimensional measurements may be chained.

Following the chainings, a ledger recognition event and its associated multidimensional measurements may be generated at operation 670. At operation 680, the derived measurements may be chained to basis measurements following the ledger recognition event.

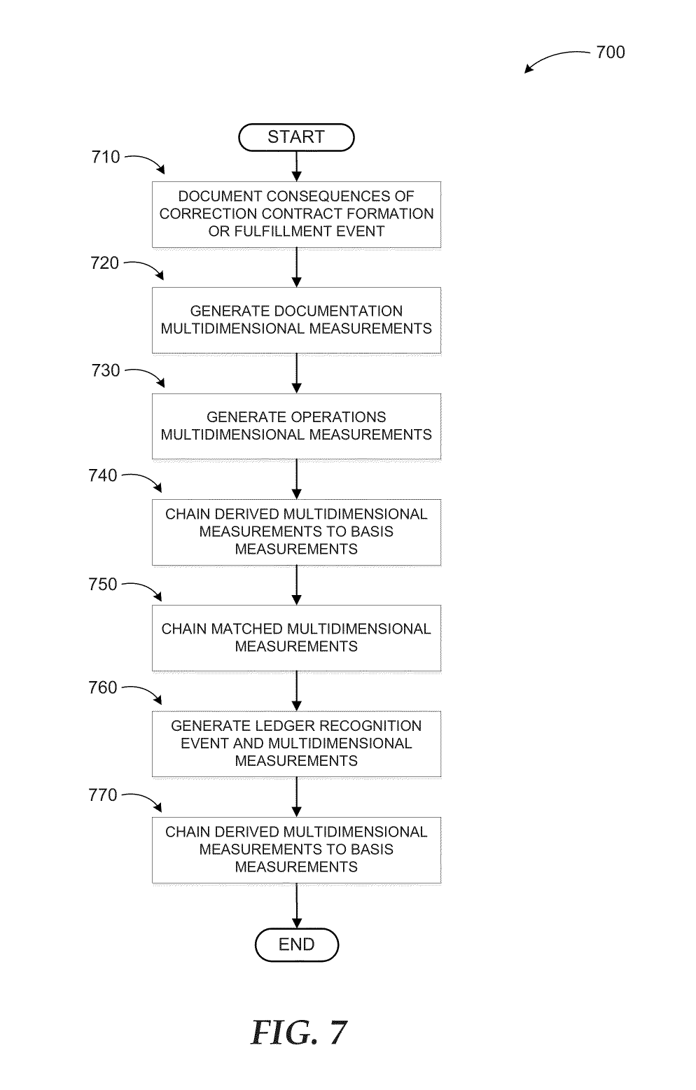

FIG. 7 illustrates a logic flow diagram for a process of providing an application process framework for an integrated and extensible accounting system, according to embodiments. Process 700 may be implemented as part of an accounting service of a locally installed application.

Process 700 begins with operation 710, where consequences of a correction contract formation or fulfillment event are documented. At operation 720, documentation multidimensional measurements may be generated. At a subsequent operation 730, operations multidimensional measurements may be generated.

At operation 740, derived multidimensional measurements may be chained to basis measurements, and matched multidimensional measurements may be chained. Following the chainings, a ledger recognition event and its associated multidimensional measurements may be generated at operation 760. At operation 770, the derived measurements may be chained to basis measurements following the ledger recognition event.

The operations included in processes 600 and 700 are for illustration purposes. Providing an approach to accounting for contract formation and fulfillment activities by combining event chaining and multidimensional measurement chaining with event and measurement matching rules that apply variance and tolerance policies during evaluation may be implemented by similar processes with fewer or additional steps, as well as in different order of operations using the principles described herein.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for accounting for contract formation and fulfillment activities, the method comprising:
documenting a consequence of one of an original contract formation and a fulfillment activity occurrence;
generating a documentation event and one or more multidimensional measurements related to the documentation event based on the documented consequence;
generating an operations event and one or more multidimensional measurements related to the operations event based on the documented consequence;
chaining the documentation event to the operations event;
generating a ledger recognition event and one or more multidimensional measurements related the ledger recognition event; and
chaining derived measurements to basis measurements based on the ledger recognition event.

2. The method of claim 1, further comprising:
chaining the derived multidimensional measurements to basis measurements following generation of the documentation event and the operations event; and
matching the derived multidimensional measurements and the basis measurements.

3. The method of claim 2, further comprising:
chaining the matched multidimensional measurements.

4. The method of claim 1, further comprising:
chaining tolerance measurements related to contract formation measurement using matching rules when matching with measurements related to the fulfillment activities, wherein the contract formation measurement includes one or more of fulfillment performance and penalty measurement.

5. The method of claim 1, further comprising:
generating the multidimensional measurements from one or more operations policies.

6. The method of claim 5, further comprising:
matching rules to the chained multidimensional measurements such that a measurement level of fulfilled and incomplete operations are available at each step.

7. The method of claim 1, further comprising:
chaining the measurements in response to a change to a documented consequence of one of a formed contract and the fulfillment activity.

8. The method of claim 1, further comprising:
chaining the measurements in response to a correction to a documented consequence of one of a formed contract and the fulfillment activity.

9. The method of claim 1, further comprising:
defining the documentation event through a documentation event type property and the operations event through an operations event type property.

10. The method of claim 1, further comprising:
relating the documentation event to the ledger recognition event through an accounting relationship type property and to the operations event through an accountability relationship type property.

11. The method of claim 1, further comprising:
relating the documentation event, the ledger recognition event, and the operations event to the multidimensional measurements through one or more event measurement relationship type properties.

12. A server executing an accounting service providing accounting for contract formation and fulfillment activities, the computing device comprising:
a memory storing instructions; and
a processor coupled to the memory, the processor executing one or more modules for the accounting service, wherein the modules are configured to:
generate a documentation event, a ledger recognition event, and an operations event based on one of an original contract formation and a fulfillment activity occurrence;
generate multidimensional measurements associated with the documentation event, the ledger recognition event, and the operations event;
chain the documentation event, the ledger recognition event, the operations event documenting a consequence of one of the original contract formation and the fulfillment activity; and
combine the event chaining and multidimensional measurement chaining with one or more event and measurement matching rules that apply variance and tolerance policies.

13. The server of claim 12, wherein the processor is configured to combine the event chaining and multidimensional measurement chaining with the event and measurement matching rules during evaluation.

14. The server of claim 12, wherein the matching rules chain tolerance measurements related to contract formation measurement when matching with measurements related to the fulfillment activities, the contract formation measurement including one or more of fulfillment performance and penalty measurement.

15. The server of claim 12, wherein the chained measurements participate in a matching rule that applies tolerance policies with the measurement chaining being updated when the documented consequence of one of the contract formation and the fulfillment activity is corrected.

16. The server of claim 12, wherein the processor is further configured to store outstanding quantities in respective multidimensional measurements.

17. The server of claim 12, wherein the modules are implemented in an application framework that enables sharing by applicable documents of one of the contract and the fulfillment activity.

18. A computer-readable memory device with instructions stored thereon for accounting for contract formation and fulfillment activities, the instructions containing:
documenting a consequence of one of a correction to a contract and a fulfillment activity occurrence;
generating one or more documentation multidimensional measurements based on the documented consequence;
generating one or more operations multidimensional measurement based on the documented consequence;
chaining derived multidimensional measurements to basis measurements following the generation of documentation multidimensional measurements and the operations multidimensional measurements;
matching the derived multidimensional measurements and the basis measurements; and
chaining the matched measurements.

19. The computer-readable memory device of claim 18, wherein instructions further comprise:
generating a ledger recognition event and one or more multidimensional measurements related the ledger recognition event; and
chaining derived measurements to basis measurements based on the ledger recognition event.

20. The computer-readable memory device of claim 18, wherein instructions further comprise:
employing a matching rule to the chained measurements that applies tolerance policies; and
updating the measurement chaining in response to one of a correction and a change in the documented consequence of one of the contract and the fulfillment activity.
